(19) United States
(12) Patent Application Publication
(10) Pub. No.: US 2006/0070505 A1
(43) Pub. Date: Apr. 6, 2006

(54) Rotary cutter drum and a rotary cutter unit with such a rotary cutter drum

(75) Inventors: Gilbert Grenier, Annonay (FR); Stephanie Baty, Vienne (FR)

Correspondence Address: Ronald L. Grudziecki;Drinker Biddle & Reath LLP, 1500 K Street, N.W., Suite 1100, Washington, DC, 20005, US

(73) Assignee: Sandvik Intellectual Property AB, Sandviken (SE)

(21) Appl. No.: 11/165,353

(22) Filed: Jun. 24, 2005

(30) Foreign Application Priority Data
Jul. 2, 2004 (SE) 0401734-9

(51) Int. Cl. B26D 1/22

(52) U.S. Cl. 83/505

(57) ABSTRACT

A rotary cutter drum includes a cutter portion formed of a multiphase material and includes first and second substantially cylindrical, radially outwardly exposed surfaces, and a knife member formed of one piece with the exposed surfaces and arranged to axially separate the first and second surfaces from one another. The knife member protrudes by a distance in the range of 1 to 5 mm radially outwardly beyond a smallest diameter portion of the first and second exposed surfaces. The knife member includes two sides terminating at respective ones of the first and second exposed surfaces.

The present application claims priority under 35 U.S.C. §119 to Patent Application Serial No. 0401734-9 filed in Sweden on Jul. 2, 2004.

### TECHNICAL BACKGROUND OF THE INVENTION

The present invention relates to a rotary cutting device for a rotary cutting apparatus, comprising at least one part made of a multiphase material, including at least one cutter portion having a first and a second substantially circular cylindrical outer surface, said cutter portion comprising at least one knife member protruding from and separating said first and second surfaces from each other, said first and second surfaces and said knife member being integral parts of said cutter portion.

The invention also relates to a rotary cutting apparatus comprising an anvil roll and such a rotary cutter.

Such a rotary cutter and such a rotary cutting unit marketed by Sandvik AB under the trade name “Sandvik CRC” (i.e. “carbide rotary cutter”) are illustrated in FIGS. 5 and 6. The known rotary cutter however suffers from the drawback that steel inserts must be taken away from the drum when re-sharpening a dull cutter. Furthermore, the inserts are screwed onto the drum, causing cumbersome screwing and unscrewing of the inserts before re-sharpening.

As shown in FIGS. 5 and 6, the rotary cutter unit A comprises a rotary cutter drum B made a multiphase material, such as a carbide, ceramics or metallic powder, in working relationship with a rotary anvil drum C. The rotary cutter drum B is provided with a cutter portion D having surfaces Ea, Eb on either side of at least one knife member F protruding integrally from said surfaces Ea, Eb, the radially outer peripheral part of said knife member F having a diameter larger than that of said surfaces Ea, Eb, respectively. The knife member F extends 6-14 mm from the surface Ea and forms a cutting edge structure at said peripheral part. The rotary cutter drum B is provided with an arbour G adapted to be connected to a driving unit, such as an electric motor (not shown).

Peripheral to the surfaces Ea, Eb there are provided a pair of annular abutment members Ha, Hb having a diameter larger than that of the surfaces Ea, Eb of said cutter portion D.

Furthermore, the abutment members Ha, Hb have a diameter which is substantially the same as the radially peripheral part of said knife member F. The annular abutment members Ha, Hb are adapted to lie against and to transmit the rotation of the rotary cutter drum B to said anvil C, such that it turns in a direction opposite to that of said rotary cutter drum B.

FIG. 6 shows that the surfaces Ea, Eb are hidden (non-outwardly exposed), i.e., they are covered by steel, plastic or rubber inserts Ja, Jb attached to the surfaces Ea, Eb by screws K. Thus, the outer surfaces of the inserts are outwardly exposed, and the inserts are not part of (i.e., they are non-integral with respect to) the cutting member 10. Also, it will be appreciate that the cutting member 10 comprises respective sides that extend divergingly from an outermost portion of the knife member. One of those sides extends toward the exposed outer surface of the insert Ja, and the other side extends toward the exposed outer surface of the insert Jb. Both of the sides extend radially inwardly past the insert's outer surfaces since the cutting member is integral with (of one piece with) the surfaces Ea and Eb that underlie the inserts. The radial extension of the knife radially outwardly past the outer surfaces of the inserts the inserts are chosen depending on the material to be cut, but lies within the range of 0.5 mm to 5 mm. Radially directed holes La are formed in the body inside the knife member. Corresponding aligning holes Lb are made in the inserts Ja. Holes Lc are also formed in the cutter portion D axially outside the knife member F; aligning holes Ld are formed also at corresponding positions of said inserts Jb.

The holes La, Lb and Lc, Ld communicate with axially extending channels M in said body, said holes La, Lb and Lc, Ld being selectively connected to a source of vacuum and/or to over pressure (alternatively atmospheric pressure) by means of a not shown control unit with suitable valves.

The holes La and Lc are provided with not shown sealings, such as O-rings or any kind of suitable gasket to seal against the inserts Ja, Jb, such that leakage between the insert and the surfaces Ea and Eb, respectively, is prevented.

The drums B, C rotate in the direction as indicated by arrows in FIG. 5. A web N is introduced into the rotary cutter unit A between the drums B and C. The holes La, Lb and Lc, Ld are controlled to be connected to the vacuum source, such that the web sticks to the insert Ja covering the surface Ea. During continued rotation, the knife cuts the web to the shape of the knife member. Substantially simultaneously, the holes La, Lb are controlled to be connected to over-pressure or atmospheric pressure, such that the cut product is released from the insert Ja and is allowed to be transported by, e.g., a not shown conveyor belt. The holes Lc, Ld are still subjected to vacuum such that the trim P, i.e., residue of the web, is allowed to stick to the insert Jb covering the surface Eb such that the trim is allowed to continue rotation together with the drum B. When the cut-out articles Q have been securely separated from the trim, the holes Lc, Ld are connected to over-pressure or atmospheric pressure, such that the trim P can be released and collected.

Instead of screwing the inserts Ja, Jb onto the surface Ea, Eb, they may be glued thereonto. In such cases, the insert may also be made of foam.

U.S. Pat. No. 5,967,009 discloses a rotary cutter having a drum made of steel provided with a plurality of knives formed in one piece with the drum. This kind of drum is disadvantageous, since the knife has limitations with respect to its size, since a knife of that kind protruding radially more than % inch (6.25 mm) would produce excessive momentum on the knife, in turn generating cracks in the steel, whereas a knife protruding less than 0.1 inch (2.5 mm) is not capable of being machined.

### SUMMARY OF THE INVENTION

The object of the invention is to achieve a less complex rotary cutting device.

The object is solved by the rotary cutter as initially defined wherein the knife member extends in the range of 1 to 5 mm radially outwardly of the one of said first and second surfaces having the smallest diameter.

Hereby is achieved that the inserts Ja, Jb of FIGS. 5 and 6 can be eliminated. Furthermore, less machining of the knife member is required.

Suitably, the outer periphery of the knife member comprises a pair of cutting edges and a slanting portion extending from each edge towards said surfaces, respectively, said slanting portion extending to at least 50% of the radial extension of said knife member. Alternatively, the slanting portion extends substantially the whole radial extension of said knife member. Hereby is achieved that grinding can be performed in a faster and easier manner; sharp corners are avoided. Furthermore, a longer life time of the edge is achieved and thus also a longer life time thereof.

It should be noted that a land surface disposed between the cutting edges may not be visible to the naked eye, since it may have an axial extension of only fractions of a millimeter.

Preferably, a plurality of openings are formed in the cutter portion adapted to be associated with a source of gas having a controllable pressure, at least one opening being arranged substantially at said knife member. Hereby, it is possible to provide the surface with more holes than previously possible, and a wider possibility of achieving a desired hole distribution, such that a more efficient connection of the web and a more efficient release of the cut article and/or the waste trim from the surface can be achieved. Furthermore, leakage occurring in the prior art between the surface and a steel insert is eliminated.

Suitably, at least one annular member is adapted to abut a rotatable anvil drum, said annular member having a diameter extending substantially to the same extent above the surface as said knife member. Hereby is achieved an optimal contact between the annular member and the anvil, and between the knife member and the anvil.

Preferably, at least one cutter portion and said at least one annular member are integral parts of a solid arbour.

Alternatively, said at least one cutter portion and said at least one annular portion are integral parts of a single sleeve having an inner surface defining an inner diameter, said sleeve being adapted to be arranged on an arbour.

Alternatively, said at least one cutter portion and one of said annular portions constitute an integrated part, whereas the other annular member constitutes a separate part of a sleeve having an inner surface defining an inner diameter, said separate parts being adapted to be arranged on an arbour to form said sleeve.

Alternatively, said at least one cutter portion and said at least one annular member are separate parts of a sleeve having an inner surface defining an inner diameter, said separate parts being adapted to be arranged on an arbour to form said sleeve.

Hereby, different options of rotary cutters are achieved.

A wall thickness of said sleeve is defined by the difference between the diameter of said inner surface and the one of the first or second outer surface having the smallest diameter, said wall thickness is suitably in the range of 1 cm-10 cm. Hereby, less multiphase material for the manufacture of the rotary cutting device is needed, compared to in prior art rotary cutters.

### DRAWING SUMMARY

In the following, preferred embodiments of the invention will be described in more detail by reference to the accompanying drawing, in which:

FIG. 1A is a perspective view of a rotary cutter unit comprised of a first embodiment of a cutter drum in engagement with an anvil drum.

FIG. 1B is an exploded perspective view of a second embodiment of a cutter drum according to the invention.

FIG. 1C is a further exploded view of FIG. 1B.

FIG. 1D is a view similar to FIG. 1C of a third embodiment of a cutter drum according to the invention.

FIG. 2 is an enlarged fragmentary view of any of the drum embodiments of FIGS. 1A-1D.

FIG. 3 is an enlarged fragmentary view of FIG. 2 of a first spatial relationship between a knife member and an abutment member according to the invention.

FIG. 4 is a view similar to FIG. 3 showing a second alternative spatial relationship between the knife member and the abutment member.

FIG. 5 is a perspective view of a prior art rotary cutter unit as it cuts a web.

FIG. 6 is an exploded perspective view of the prior art cutting drum used in FIG. 5.

### DESCRIPTION OF PREFERRED EMBODIMENTS

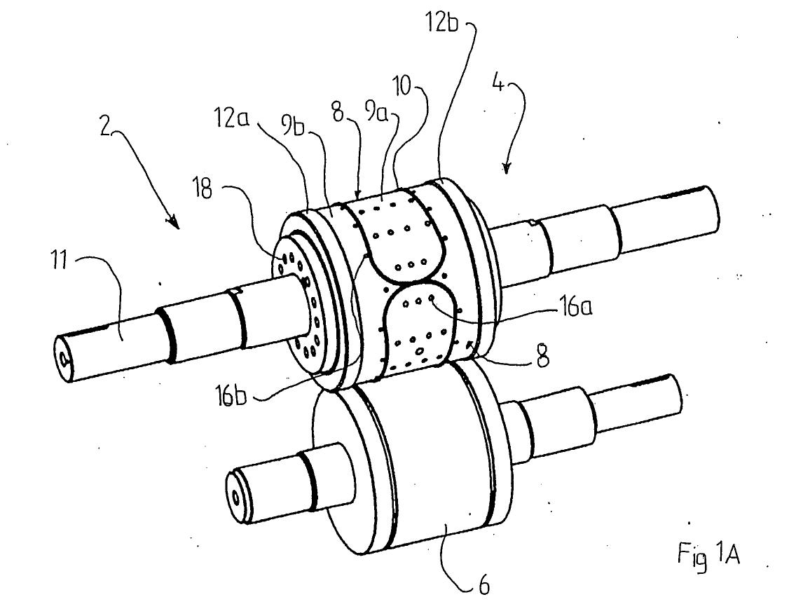

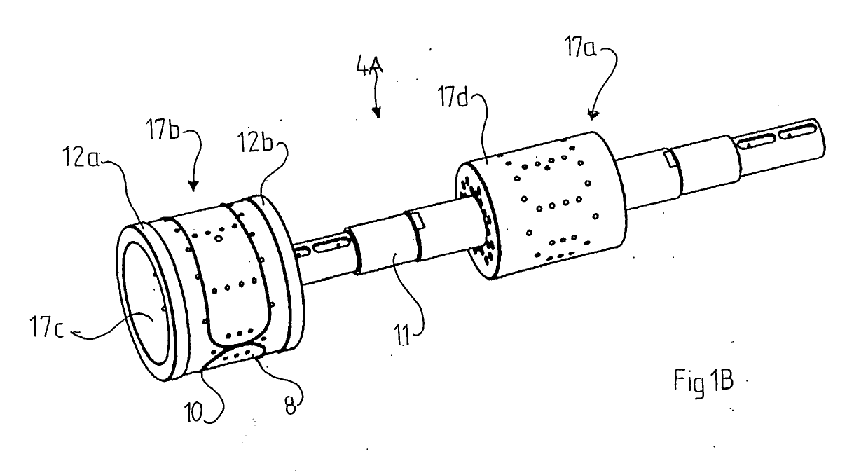

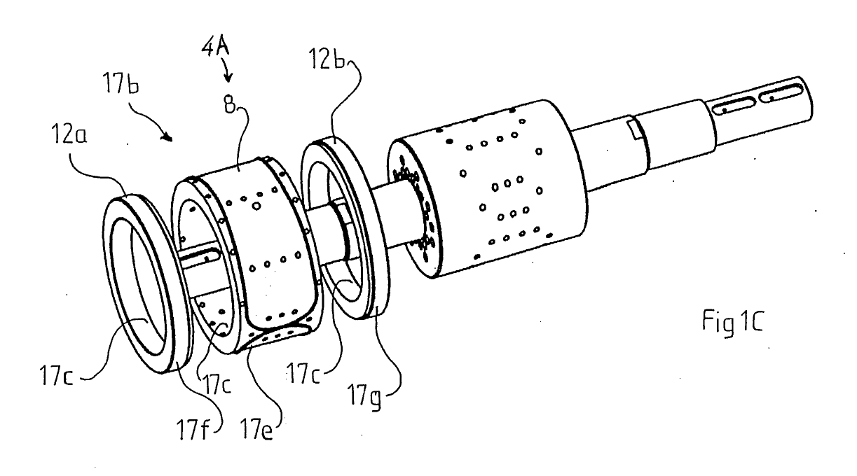

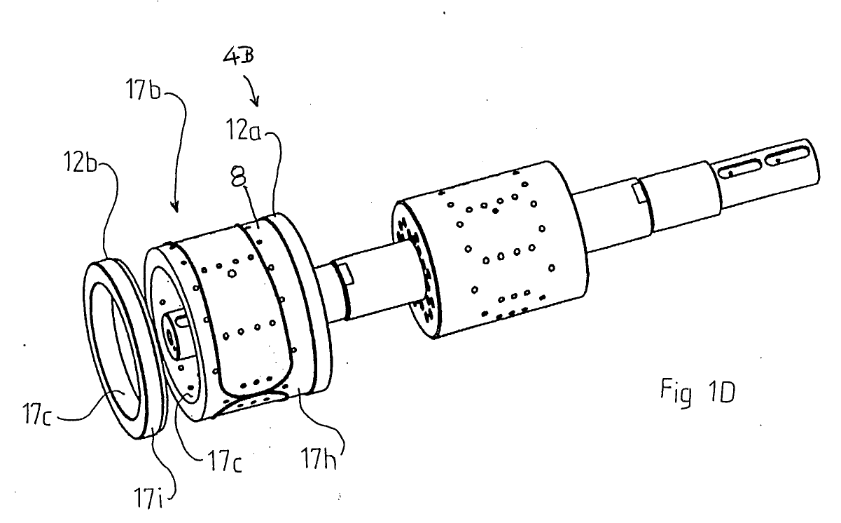

FIG. 1A shows a rotary cutter unit 2 comprising a rotary cutter drum 4 made of a multiphase material, such as a carbide, ceramics or metallic powder, arranged in working relationship with a rotary anvil drum 6.

The drum 4 is generally solid and has a pair of annular abutment members 12a, 12b, produced in one piece of a multiphase material, such as a carbide or ceramics. The rotary cutter drum 4 is provided with a cutter portion 8 situated axially between the abutment members 12a, 12b. The cutter portion has outwardly exposed surfaces 9a, 9b on either side of at least one endless knife member 10 of the cutter portion, which knife member protrudes radially outwardly beyond said surfaces 9a, 9b. The radially outer periphery of the knife member 10 has a diameter larger than that of each of said surfaces 9a, 9b.

The knife member 10 extends 6-14 mm from the surface 9a and forms a cutting edge structure at its radially outer periphery. The rotary cutter drum 4 is provided with an arbour 11 adapted to be connected to a driving unit, such as an electric motor (not shown).

Peripheral to the surfaces 9a, 9b there are provided the pair of annular abutment members 12a, 12b having a diameter larger than that of the surfaces 9a, 9b of said cutter portion 8.

Furthermore, the abutment members 12a, 12b have a diameter which is substantially the same as the radially peripheral part of said knife member 10. The annular abutment members 12a, 12b are adapted to lie against, and transmit the rotation of the rotary cutter drum 4 to said anvil 6, such that the anvil turns in a direction opposite to that of said rotary cutter drum 4.

Radially directed holes 16a are formed in the cutter portion 8 axially internally of the knife member 10. Holes 16b are also formed in the cutter portion 8 axially outside of the knife member 10.

The holes 16a, 16b communicate with axially extending channels 18 in said body, said holes 16a, 16b being selectively connected to a source of vacuum and/or to an over pressure (alternatively atmospheric pressure) by means of a not shown control unit with suitable valves.

FIG. 1B shows a rotary cutter drum 4A according to a second embodiment of the invention adapted to be arranged in working relationship with a rotary anvil drum 6 to form a rotary cutting unit. According to this embodiment, the drum 4 is constituted by an arbour part 17a and a sleeve part 17b, the sleeve part having a cutter portion 8 with at least one knife member 10 and an annular abutment member 12a, 12b on each side of said cutter portion 8. The arbour part 11 is preferably made of steel, whereas the sleeve part is preferably made of a multiphase material. The sleeve part 17b has an inner surface 17c, the diameter of which is slightly smaller that that of the outer surface 17d of the arbour part 17a.

The sleeve part 17b is mounted on the arbour part 17a by press fit. This is performed by subjecting the arbour part 17a to a cold atmosphere in order to make it shrink, whereafter the sleeve part 17b can easily be slid onto the arbour part 17a, and the corresponding holes of the sleeve part and the arbour part can be readily aligned with one another.

When sleeve part 17b needs to be serviced, e.g., due to a dull knife member 10, the sleeve part 17b is slid off the arbour part 17a after performing a cold treatment on the arbour part.

As shown in FIG. 1C, the sleeve part 17b may be divided into three pieces, i.e., a knife part 17e comprising the cutter portion 8 and two separate parts 17f, 17g, comprising said abutment members 12a, 12b.

As shown in FIG. 1D, the sleeve portion 17b of a drum 4B may instead be divided into two pieces, wherein the cutter portion 8 and one of the abutment members 12a constitute one part 17h, and the other of said abutment members 12b constitutes a second part 17i.

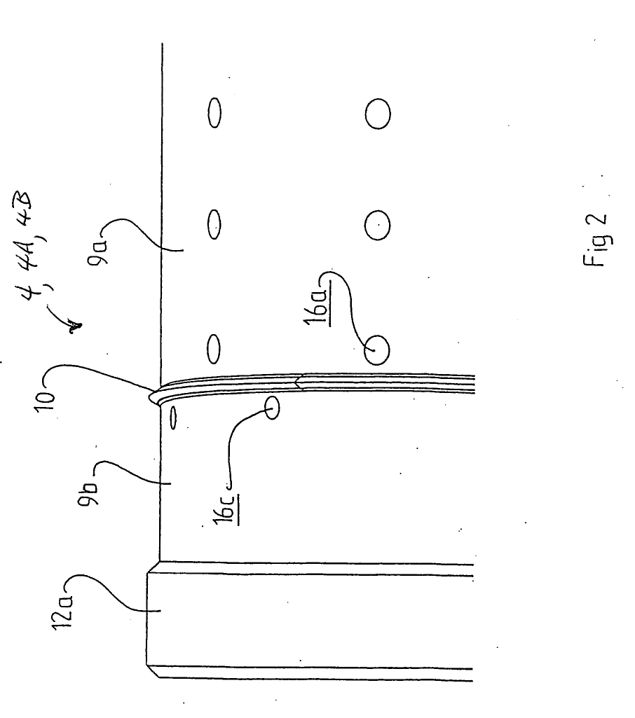

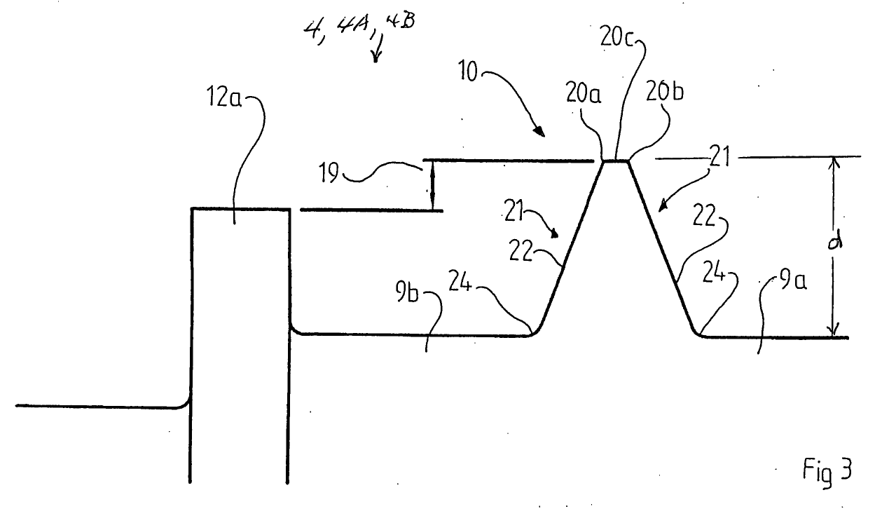

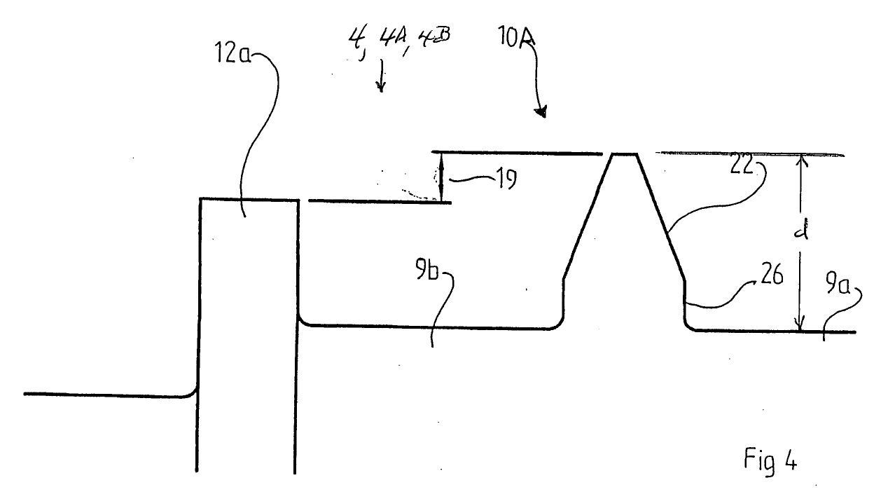

FIGS. 2-4 show the knife member 10, the surfaces 9a, 9b and one of the annular abutment members 12a of any of the embodiments shown in FIGS. 1A-1D. The knife member 10 extends by a radial distance d in the range of 1 mm to 5 mm radially outwardly beyond the surfaces 9a and 9b, assuming that the surfaces 9a and 9b have equal diameters. If those surfaces have different diameters, then the knife member 10 extends by a distance d in the range of 1 mm to 5 mm radially outwardly beyond the surface 9a or 9b having the smaller diameter. Stated differently, the knife member extends by a distance d in the range of 1 mm to 5 mm radially outwardly beyond a smallest diameter portion of the first and second exposed surfaces 9a, 9b. The annular abutment member 12a extends substantially to the same elevation, i.e., to substantially the same location radially outwardly of the surface 9a as the knife member 10. However, there may be a slight difference 19 (FIG. 3) in radial extension between members 12a and 10 may, e.g., in the range of −0.5 mm to +0.5 mm, depending on the material of the web to be cut. This difference 19 is shown as a positive value in FIGS. 3 and 4.

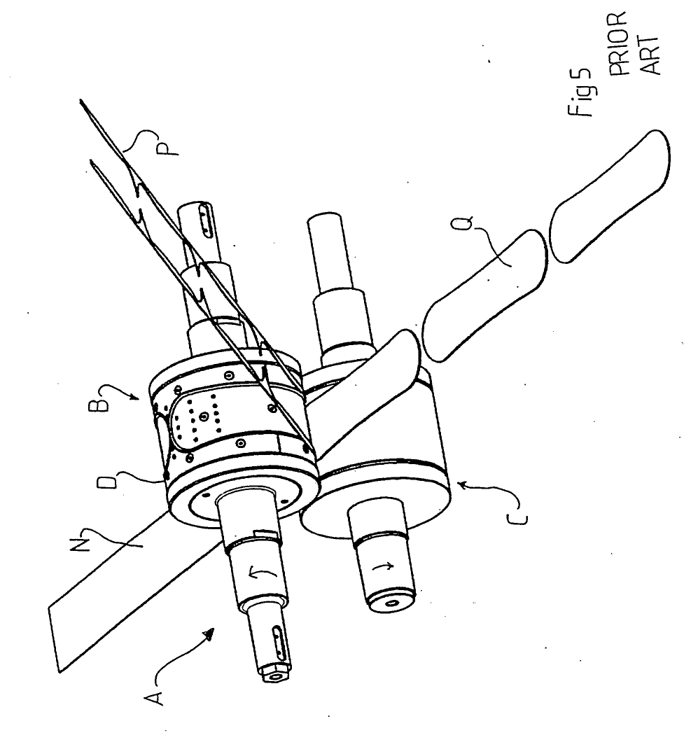

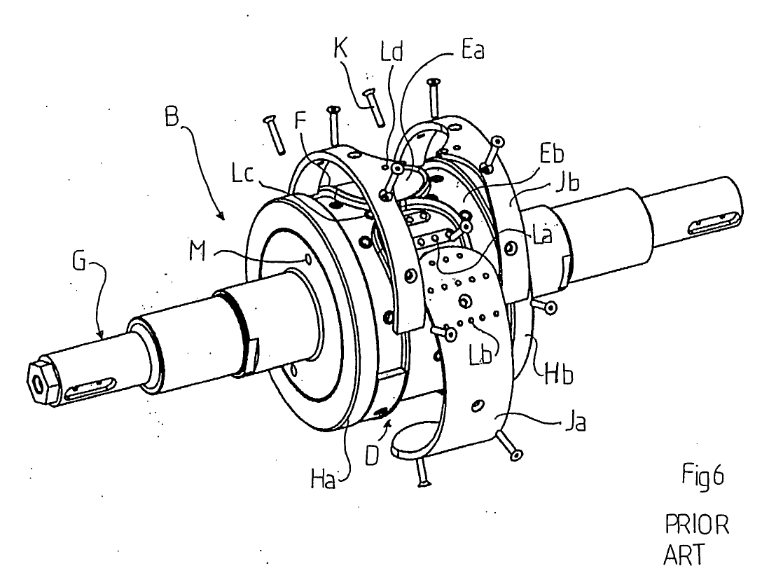

The cutting operation of the embodiments shown in FIGS. 1A-1D is performed in the manner described in connection with FIGS. 5 and 6 above regarding the prior art. However, as shown in FIG. 2, it has also been possible to form the holes 16a, 16b close to the knife member 10, which is impossible in the prior art rotary cutter shown in FIGS. 5 and 6, since that would cause leakage problems between the inserts Ja, Jb and the surfaces Ea, Eb.

As shown in FIG. 3, the radially outer cutting edge structure of the knife member 10 comprises a pair of cutting edges 20a, 20b separated axially by a land area 20c. On either sides of the edges 20a, 20b, a side portion 21 terminates radially inwardly at the exposed surfaces 9a, 9b, respectively. The side portion 21 comprises a slanting portion 22 and a concavely curved portion 24 for facilitating manufacture of the edge, such that the strength thereof becomes optimal. The slanting portions diverge toward the surfaces 9a, 9b.

It should be noted that the land area 20c might not be visible to the naked eye, i.e., it can be in the range of 1 μm and 0.5 mm.

According to FIG. 4, a modified knife member 10A comprises a slanting portion 22 and a substantially radially extending portion 26. However, the radially extending portion constitutes less than half the height of the knife member 10.

Although the present invention has been described in connection with a preferred embodiment thereof, it will be appreciated by those skilled in the art that additions, deletions, modifications, and substitutions not specifically described may be made without departing from the spirit and scope of the invention as defined in the appended claims.

What is claimed is:

1. A rotary cutter drum comprising a cutter portion formed of a multiphase material and including:
first and second substantially cylindrical, radially outwardly exposed surfaces, and
a knife member formed of one piece with the exposed surfaces and arranged to axially separate the first and second surfaces from one another, the knife member protruding by a distance in the range of 1 to 5 mm radially outwardly beyond a smallest diameter portion of the first and second exposed surfaces.

2. The rotary cutter drum according to claim 1 wherein the knife member includes a radially outer portion and first and second sides extending from the outer portion toward the first and second exposed surfaces, respectively, wherein the first and second sides terminate radially inwardly at the respective first and second exposed surfaces.

3. The rotary cutter drum according to claim 1 wherein the radially outer periphery of the knife member includes first and second axially separated cutting edges from which the respective first and second sides extend, the first and second sides including first and second slanting portions, respectively, extending from the respective first and second edges in diverging relationship and extending to at least a midpoint of the radial outward extension of the knife member.

4. The rotary cutter drum according to claim 3 wherein the first and second slanting portions extend substantially all the way to the respective first and second exposed surfaces.

5. The rotary cutter drum according to claim 3 wherein the cutter portion includes a plurality of radial through-openings adapted to be connected to a pressure source, at least one of the openings disposed at the knife member.

6. The rotary cutter drum according to claim 1 further including an annular abutment member arranged coaxially with the cutter portion and having an outer abutment surface extending radially outwardly to substantially the same elevation as the knife member.

7. The rotary cutter drum according to claim 6 wherein the cutter portion comprises a substantially solid arbour.

8. The rotary cutter drum according to claim 6 wherein the cutter portion and the annular abutment member constitute integral pieces of a single hollow sleeve mounted on an arbour.

9. The rotary cutter drum according to claim 6 wherein the abutment member constitutes a first abutment member, the drum further comprising a second, axially spaced abutment member, one of said first and second abutment members being of one-piece construction with the cutter portion, and the other of the first and second abutment portions comprising a piece that is separate from the cutter portion.

10. The rotary cutter drum according to claim 6 wherein the abutment member constitutes a first abutment member, the drum further including a second, axially spaced abutment member, wherein both of the first and second abutment members comprise pieces separate from the cutter portion.

11. The rotary cutter drum according to claim 8 wherein a wall thickness of the sleeve is defined by a radial distance from an inner surface of the sleeve to a smallest outer diameter of the sleeve, the wall thickness being in the range of 1 cm to 10 cm.

12. The rotary cutter drum according to claim 1 wherein the first and second exposed surfaces are of the same diameter.

13. A rotary cutter unit comprising a rotary anvil roll and a rotary cutter drum disposed opposite thereto, the rotary cutter drum comprising:
first and second substantially cylindrical, radially outwardly exposed surfaces, and
a knife member formed of one piece with the exposed surfaces and arranged to axially separate the first and second surfaces from one another, the knife member protruding by a distance in the range of 1 to 5 mm radially outwardly beyond a smallest diameter portion of the first and second exposed surfaces.

14. The rotary cutting unit according to claim 13 wherein the knife member includes a radially outer portion and first and second sides extending from the outer portion toward the first and second exposed surfaces, respectively, wherein the first and second sides terminate radially inwardly at the respective first and second exposed surfaces.

15. The rotary cutting unit according to claim 13 wherein the radially outer periphery of the knife member includes first and second axially separated cutting edges from which the respective first and second sides extend, the first and second sides including first and second slanting portions, respectively, extending from the respective first and second edges in diverging relationship and extending to at least a midpoint of the radial outward extension of the knife member.

16. The rotary cutting unit according to claim 15 wherein the first and second slanting portions extend substantially all the way to the respective first and second exposed surfaces.

17. The rotary cutting unit according to claim 15 wherein the cutter portion includes a plurality of radial through-openings adapted to be connected to a pressure source, at least one of the openings disposed at the knife member.

18. The rotary cutting unit according to claim 13 further including an annular abutment member arranged coaxially with the cutter portion and having an outer abutment surface extending radially outwardly to substantially the same elevation as the knife member.

19. The rotary cutting unit according to claim 18 wherein the cutter portion comprises a substantially solid arbour.

20. The rotary cutting unit according to claim 18 wherein the cutter portion and the annular abutment member constitute integral pieces of a single hollow sleeve mounted on an arbour.
